(19) United States
(12) Patent Application Publication
(10) Pub. No.: US 2024/0383113 A1
(43) Pub. Date: Nov. 21, 2024

(54) TORQUE SCREWDRIVER

(71) Applicants: Liang Hua, Hangzhou (CN); Linwei Xue, Hangzhou (CN)

(72) Inventor: Jun Shao, Huangshan (CN)

(21) Appl. No.: 18/792,522

(22) Filed: Aug. 1, 2024

(30) Foreign Application Priority Data
Jul. 26, 2024 (CN) 202421805503.1

(51) Int. Cl. B25B 23/14; B25B 15/02

(52) U.S. Cl. CPC B25B 23/141; B25B 15/02

(57) ABSTRACT

The present disclosure relates to the technical field of screwdrivers. Specifically, the torque screwdriver includes a screwdriver handle and an auxiliary scale ring; a screw rod is arranged inside the screwdriver handle; a bearing is arranged on a side surface of the screw rod; a main scale pipe is connected to an outer side of the bearing; an outer side of the main scale pipe is connected with the auxiliary scale ring; and a nut is arranged on an outer side of the auxiliary scale ring. During use of the device, when the screwdriver reaches a fixed torque, the device will slip if the device is continued to be rotated, so as to protect a screw and avoid the screw from being damaged.

### TECHNICAL FIELD

The present disclosure relates to the technical field of screwdrivers, and in particular, to a torque screwdriver.

### BACKGROUND

A screwdriver can be embedded in a screw, making it easier to drive the screw to rotate. However, a torque of a general screwdriver cannot be set during rotation. Thus, during rotation, a thread of a screw will be damaged if a high force is applied to the screw. It is not conductive to use of the screwdriver.

### SUMMARY

The present disclosure aims to provide a torque screwdriver, so as to solve the problems mentioned in the background section.

A torque screwdriver includes a screwdriver handle and an auxiliary scale ring, wherein a screw rod is arranged inside the screwdriver handle; a bearing is arranged on a side surface of the screw rod; a main scale pipe is connected to an outer side of the bearing; an outer side of the main scale pipe is connected with the auxiliary scale ring; and a nut is arranged on an outer side of the auxiliary scale ring.

Preferably a second spring is arranged on a side surface of one end, located outside the screwdriver handle, of the screw rod; an adjustment ring is arranged on a side surface of the second spring; and the main scale pipe is mounted in the adjustment ring in an embedded manner.

Preferably, a square insert is arranged at a tail end in the screwdriver handle; an M5 grub screw is arranged on a side surface of the square insert; a gasket is arranged on a side surface of the M5 grub screw; and a first spring is arranged on a side surface of the gasket.

Preferably, a third steel ball is arranged on a side surface of the first spring; a second steel ball is arranged on a side surface of the third steel ball; the second steel ball and the third steel ball are mounted in the screw rod in an embedded manner; and a concave wheel is arranged on an outer side of the screw rod.

Preferably, a first steel ball is arranged on an outer side of the main scale pipe, and a second spring is arranged on an outer side of the first steel ball.

Beneficial effects of the present disclosure are as follows:
1. During use of the device, when the screwdriver reaches a fixed torque, the device will slip if the device is continued to be rotated, so as to protect a screw and avoid the screw from being damaged.

### BRIEF DESCRIPTION OF THE DRAWINGS

The accompanying drawings are intended to provide a further understanding of the present disclosure and constitute a part of this specification. The accompanying drawings and the embodiments of the present disclosure are used together for explaining the present disclosure rather than constituting a limitation on the present disclosure. In the drawings:

FIG. 1 is a schematic diagram of an entire three-dimensional structure of the present disclosure;

FIG. 2 is a schematic structural diagram of an entire front-sectional view of the present disclosure;

FIG. 3 is a schematic structural diagram of mounting of a screwdriver handle and a main scale pipe of the present disclosure; and

FIG. 4 is a schematic structural diagram of mounting of a first spring and a screwdriver handle of the present disclosure.

In the drawings: 1: screwdriver handle; 2: square insert; 3: concave wheel; 4: gasket; 5: screw rod; 6: main scale pipe; 7: nut; 8: auxiliary scale ring; 9: adjustment ring; 10: first spring; 11: first steel ball; 12: second spring; 13: second steel ball; 14: M5 grub screw; 15: bearing; and 16: third steel ball.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

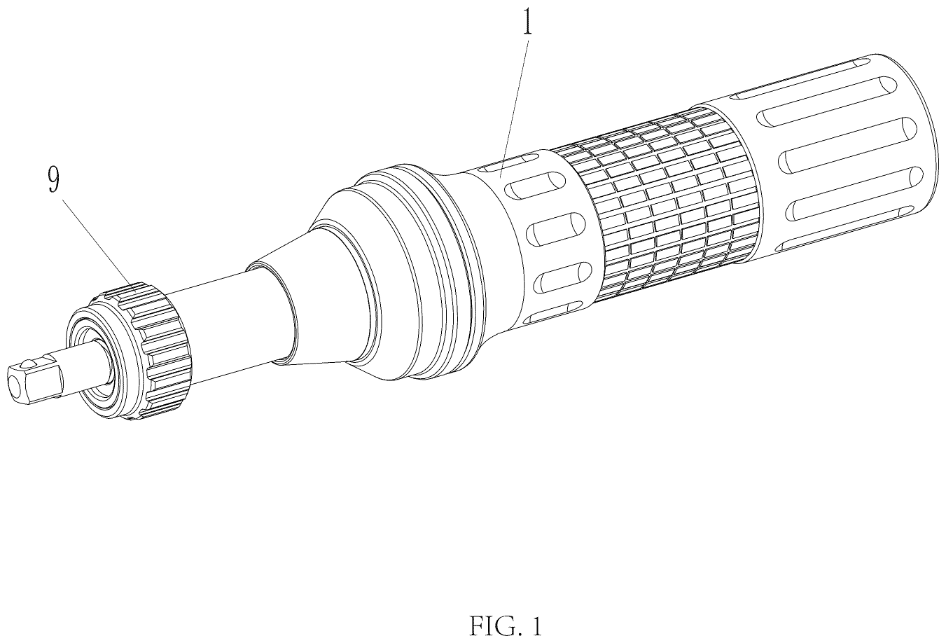

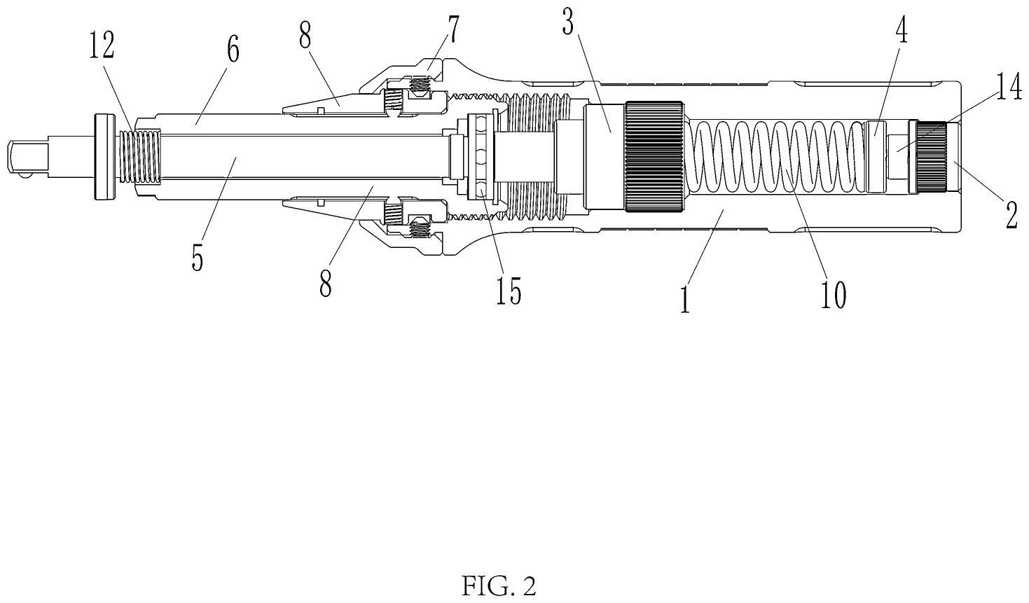

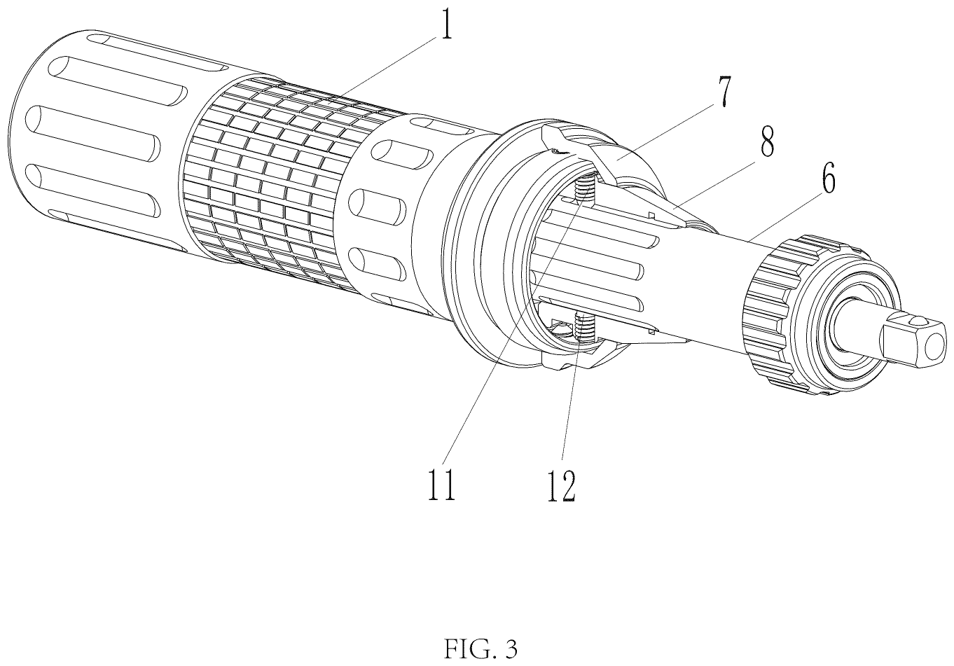

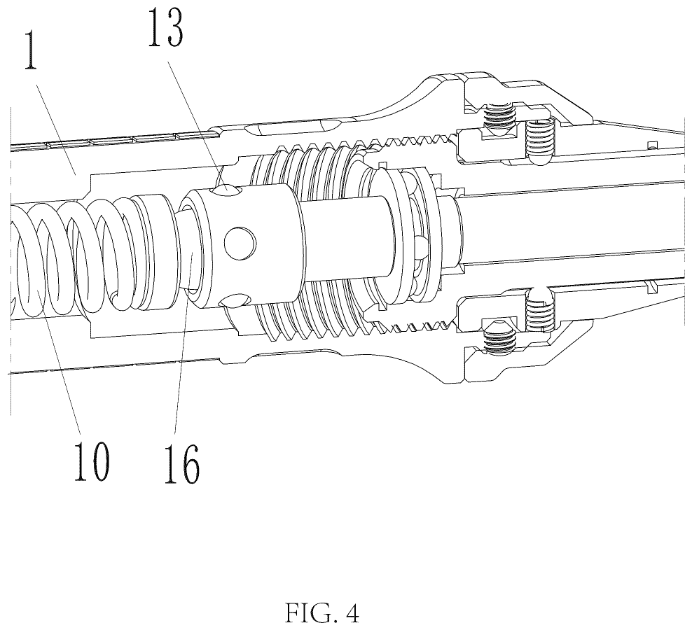

During specific implementation, as shown in FIG. 1 to FIG. 4, a torque screwdriver includes a screwdriver handle and an auxiliary scale ring, wherein a screw rod is arranged inside the screwdriver handle; a bearing is arranged on a side surface of the screw rod; a main scale pipe is connected to an outer side of the bearing; an outer side of the main scale pipe is connected with the auxiliary scale ring; and a nut is arranged on an outer side of the auxiliary scale ring.

A second spring is arranged on a side surface of one end, located outside the screwdriver handle, of the screw rod; an adjustment ring is arranged on a side surface of the second spring; and the main scale pipe is mounted in the adjustment ring in an embedded manner.

A square insert is arranged at a tail end in the screwdriver handle; an M5 grub screw is arranged on a side surface of the square insert; a gasket is arranged on a side surface of the M5 grub screw; and a first spring is arranged on a side surface of the gasket.

A third steel ball is arranged on a side surface of the first spring; a second steel ball is arranged on a side surface of the third steel ball; the second steel ball and the third steel ball are mounted in the screw rod in an embedded manner; and a concave wheel is arranged on an outer side of the screw rod.

A first steel ball is arranged on an outer side of the main scale pipe, and a second spring is arranged on an outer side of the first steel ball.

Working Principle:

A specific torque value can be set for the torque screwdriver 1 to tighten a screw with a precise torque and prevent the screw from being damaged.

The adjustment ring 9 is pulled backwards to perform axial rotation. Anticlockwise rotation increases the torque, and clockwise rotation decreases the torque.

The adjustment ring 9 drives the main scale pipe 6 to rotate, and a fixed end of the screw rod 7 is designed with the bearing 15, making the rotation easier.

In a rotation process, the main scale pipe 6 compress the internal spring 12. Laser torque scales are provided on the main scale pipe 6. Auxiliary scales are provided on the auxiliary scale ring 8 to finely adjust the torque.

The first spring 10 is provided with the specific gasket 4 at a front end. One end of the gasket 4 is in contact with the first spring 10, and the other end is in contact with the third steel ball 16.

The third steel ball is located in a hole of the square insert. There are five steel ball positions on a hole wall. A gear ring is arranged on outer sides of the steel ball positions. Spline teeth are provided at a periphery of the gear ring. The spline teeth are combined with the screwdriver handle 1 into a whole through an extrusion process.

A front surface of the square insert is connected to a fastening screwdriver or sleeving tool. In the process of rotating the plastic handle, five steel balls are simultaneously compressed when being in contact with a convex surface. During the compression, the steel balls move backwards under the compression. In the moving process, a torque is generated due to the resistance of the springs. In the process that the second steel ball moves to a concave surface, the second spring is released. In this process, a set torque is released.

After the screwdriver reaches the set torque value, the screwdriver performs a slipping action to protect the screw.

It should be noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device.

It should be finally noted that: The foregoing embodiments are merely preferred embodiments of the present disclosure, but not intended to limit the present disclosure. Although the present disclosure is described in detail with reference to the foregoing embodiments, a person of ordinary skill in the art may still make modifications to the technical solutions described in the foregoing respective embodiments or make equivalent replacements to partial technical features thereof. Any modification, equivalent replacement, and improvement made within the spirit and scope of the present disclosure shall fall within the protection scope of the present disclosure.

What is claimed is:

1. A torque screwdriver, comprising a screwdriver handle (1) and an auxiliary scale ring (8), wherein a screw rod (5) is arranged inside the screwdriver handle (1); a bearing (15) is arranged on a side surface of the screw rod (5); a main scale pipe (6) is connected to an outer side of the bearing (15); an outer side of the main scale pipe (6) is connected with the auxiliary scale ring (8); and a nut (7) is arranged on an outer side of the auxiliary scale ring (8).

2. The torque screwdriver according to claim 1, wherein a second spring (12) is arranged on a side surface of one end, located outside the screwdriver handle (1), of the screw rod (5); an adjustment ring (9) is arranged on a side surface of the second spring (12); and the main scale pipe (6) is mounted in the adjustment ring (9) in an embedded manner.

3. The torque screwdriver according to claim 2, wherein a square insert (2) is arranged at a tail end in the screwdriver handle (1); an M5 grub screw (14) is arranged on a side surface of the square insert (2); a gasket (4) is arranged on a side surface of the M5 grub screw (14); and a first spring (10) is arranged on a side surface of the gasket (4).

4. The torque screwdriver according to claim 3, wherein a third steel ball (16) is arranged on a side surface of the first spring (10); a second steel ball (13) is arranged on a side surface of the third steel ball (16); the second steel ball (13) and the third steel ball (16) are mounted in the screw rod (5) in an embedded manner; and a concave wheel (3) is arranged on an outer side of the screw rod (5).

5. The torque screwdriver according to claim 1, wherein a first steel ball (11) is arranged on an outer side of the main scale pipe (6), and a second spring (12) is arranged on an outer side of the first steel ball (11).
